(19) United States
(12) Patent Application Publication
(10) Pub. No.: US 2025/0087770 A1
(43) Pub. Date: Mar. 13, 2025

(54) Interoperable Micropower Source

(71) Applicant: Expeditionary Energy, LLC, Williamsville, NY (US)

(72) Inventors: David M. Dudas, Ijamsville, MD (US); Ronald Van Splunder, Williamsville, NY (US); Dean Fuller, Williamsville, NY (US); Robert Laschinger, Clarence, NY (US)

(21) Appl. No.: 18/826,292

(22) Filed: Sep. 6, 2024

Related U.S. Application Data
(60) Provisional application No. 63/537,057, filed on Sep. 7, 2023.

(51) Int. Cl. H01M 10/42; H01M 50/505; H02J 7/00

(52) U.S. Cl. CPC H01M 10/4257; H01M 50/505; H02J 7/00036; H02J 7/0013; H02J 7/0048; H02J 7/0063; H01M 2010/4271; H01M 2010/4278; H02J 2207/20

(57) ABSTRACT

A secondary battery module containing an energy storage device; an integrated voltage converter; power switching network; and charge controller that is configured via a variable pull-down resistor attached to an input contact to configure a plurality of autonomous modes without user input. The pull-down resistor is typically embedded in accessory cables or equipment attached to the battery module. Autonomous modes include energy harvesting, energy sharing, MPPT photovoltaic charging, USB port power source, programmable power supply, ideal diode output control, etc. In addition, the battery contains a digital communication bus that allows for full control of all functions by an external controller. A scalable power system is implemented with multiple battery modules attached to an external controller and common bus bar to increase power output and battery system capacity. The external bus bar controller implements battery output control, battery balancing and battery charging using the integrated voltage converters and power switching networks contained in the battery modules.

### TECHNICAL FIELD

The present invention relates generally to the field of battery systems, and more particularly to a high capacity, multiple cell battery system and a method of using such a system.

### BACKGROUND ART

U.S. Patent Publication Nos. US20230148400 A1, US20160380455 A1, and US 202120043818 A1 disclose power supplies and battery circuits.

### BRIEF SUMMARY OF THE INVENTION

With parenthetical reference to the corresponding parts, portions or surfaces of the disclosed embodiment, merely for the purposes of illustration and not by way of limitation, the present invention provides a battery module (1) that includes a plurality of battery cells (2) configured to store electrical energy. A battery management system (BMS) (3) is coupled to the plurality of battery cells (2). The BMS (3) is configured to monitor and manage the performance and safety of the of the battery cells (2).

A battery load switch (4) is operatively connected between the plurality of battery cells (2) and an external load (9). The battery load switch (4) is configured to selectively connect and disconnect the battery cells (2) from the load (9).

A bidirectional voltage converter circuit (5) is connected to the plurality of battery cells (2) and the battery load switch (4). The bidirectional converter circuit (5) is configured to convert voltage levels during charging and discharging of the battery cells (2). A control unit (6) is disposed in communication with the battery management system (3), the battery load switch (4), and the bidirectional voltage circuit (5) wherein the control unit (6) is configured to: receive operational data from the battery management system (3), control the operation of the battery load switch (4) based on the received operational data, and regulate the bidirectional voltage converter circuit (5) to manage the flow of energy between the battery cells (2) and the external load (9).

The invention provides a portable secondary battery and more specifically a high capacity, multiple cell battery system with integrated power conversion, power control, and multiple modes of operation. The multiple modes of operation require a method to select the mode depending on the application and state of use. The method requires little or no input from the user to select the different modes.

Also, some applications require more power than one battery can supply. Accordingly, the present invention combines multiple batteries into a larger battery bank to supply more current and capacity.

The present disclosure relates to a multifunction, secondary battery module with various power output and charging capabilities to be used alone, or in combination with multiple modules in parallel to form a scalable power system for increased capacity (amp-hours) and output current.

A secondary battery module containing a power source, integrated voltage converter, power switching network and charge controller is configured via a resistor input to operate in a plurality of autonomous modes. In addition, the battery contains a digital communication bus that allows for full control of all functions and power flow by an external controller.

The battery module contains an ideal diode circuit that may be enabled to allow multiple batteries to be connected in parallel for increased total output power.

The internal voltage converter may be configured to implement a charger that accepts and adapts to any input power source 3.6 V-26 V.

The internal voltage converter can be configured to implement maximum power point tracking (MPPT) for charging directly from the output of a photovoltaic panel.

The charger may draw power at voltages above and below battery voltage.

The battery operates in autonomous mode by default, without external controller.

Maximum power point tracking (MPPT) can be implemented across multiple connected batteries without added external power switches.

All power switching elements and power conversion elements used for the battery bus bar may be contained in the removable battery module.

### BRIEF DESCRIPTION OF THE DRAWINGS

FIG. 1 is a Mode 1 operational diagram of the system with a load.

FIG. 2 is a Mode 1 operational diagram showing charging from a wide voltage range source (power scavenging).

FIG. 3 is a Mode 1 operational diagram showing connection to an external smart charger with connection to a data bus (SMBus).

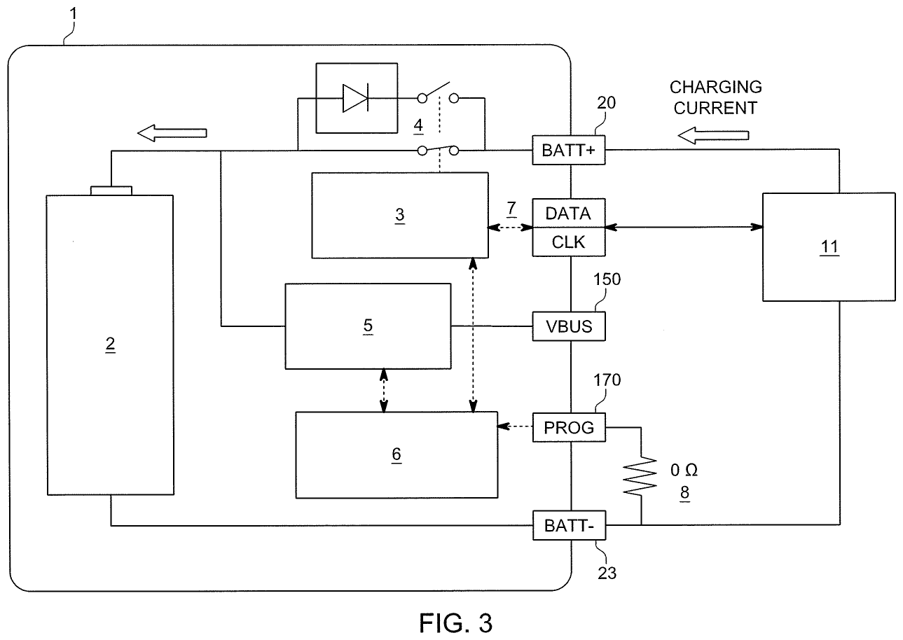

FIG. 4 is a Mode 1 operational diagram showing simultaneous connections to a load and a charging source.

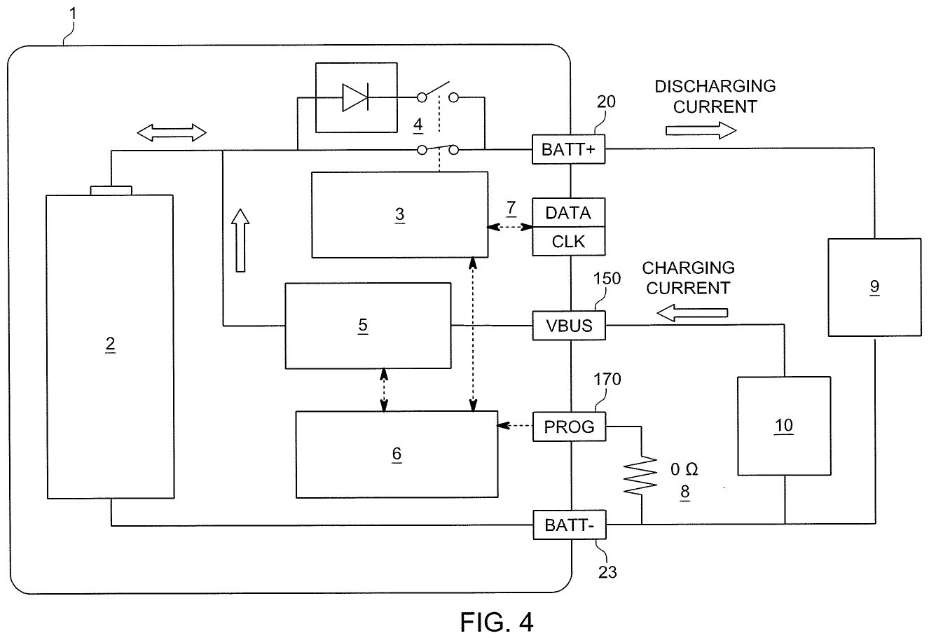

FIG. 5 is a Mode 1 operational diagram showing power transfer from battery module (1A) to battery module (1B).

FIG. 6 is a Mode 3 operational diagram showing direct connection to a photovoltaic panel for MPPT (maximum power point tracking) charging.

FIG. 7 is a Mode 4 operational diagram showing PPS (programmable power supply) output +5V @3 A to implement a USB-C power source.

FIG. 8 is a mode 2 operational diagram showing ideal diode output mode to passively connect the outputs and charging inputs of multiple battery modules in parallel.

FIG. 9 is a Mode 9 operational diagram showing the connection of multiple battery modules (1A, 1B, . . . ) to a passive bus bar with central battery module control unit (11).

FIG. 10 is a perspective view of the battery module.

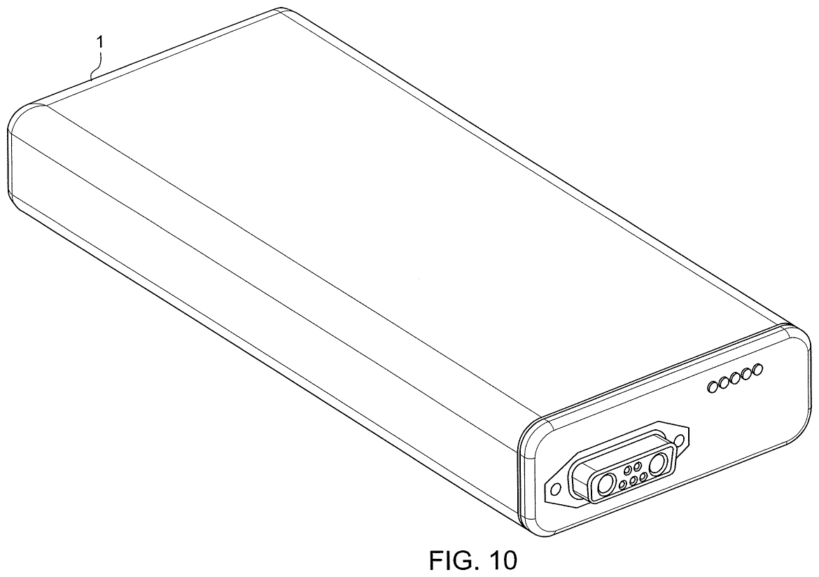

FIG. 11 is a detailed view of the electrical connections for a battery module.

FIG. 12 is a perspective view of the battery bus bar with battery modules installed.

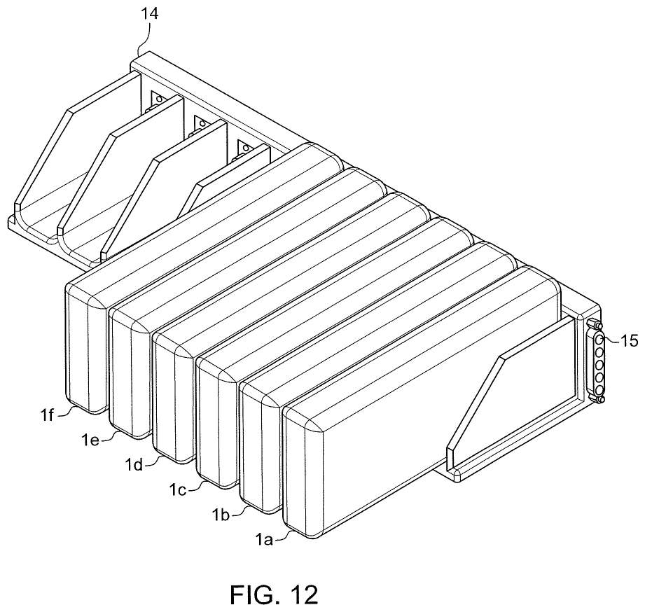

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

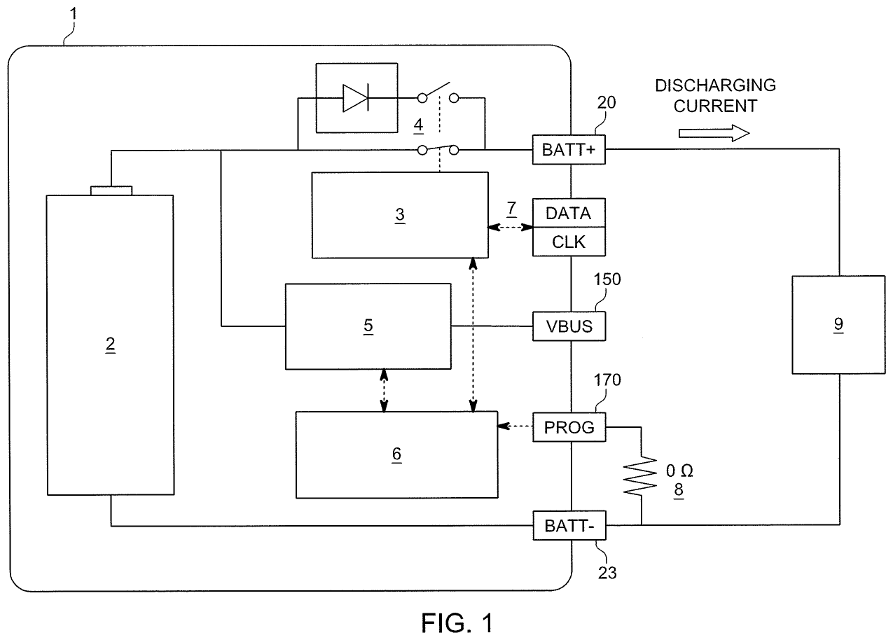

Referring now to the drawings, and more particularly to FIG. 1 thereof, battery module 1 includes one or a plurality of battery cells 2 connected in series to an output terminal pair BATT+ 20 and BATT− 23. A load switch 4 is connected between the battery cells 2 and the output terminal BATT+ 20 and provides binary (on/off) control of the charge/discharge current of battery module 1. A battery management system (BMS) 3 enables and disables the load switch 4 to control discharging and external charging of the battery cells 2. BMS 3 monitors the voltage and current of the battery cells 2 to prevent unsafe operation. The BMS 3 disconnects the load switch 4 in response to detecting battery current above a safe threshold or voltage above or below a safe limit.

The BMS 3 also implements an ideal diode function using the load switch 4. When the ideal diode mode is enabled, the BMS 3 disconnects the load switch 4 if the BATT+ 20 voltage rises above the voltage of the battery cells 2, preventing current flow into the cells 2 (charging). The ideal diode mode of the BMS 3 is enabled by the control unit 6. The ideal diode mode works in series with the battery protection functions of the BMS 3.

The DATA and CLK lines of communication port 7 are used to establish an optional communication interface between the battery module 1 and a host system. This interface may be implemented as SMBus, CAN, 12C, etc.

The VBUS contact 150 is a bidirectional power port. The bidirectional DC-DC converter 5 connects between the battery cells 2 and the VBUS contact 150. The mode and direction of the VBUS is determined by the bidirectional DC-DC converter 5, which is determined by the control unit 6.

The battery control unit 6 detects the PROG pin 170 pull down resistance 8, then sets the operational mode of the battery module 1.

The control unit 6 exits low power sleep mode when a current is detected between the PROG contact 170 and BATT− 23 contact above a certain threshold due to an attached resistance 8 (or applied voltage or current). Control unit 6 then executes a power-on-reset (POR) routine in which the PROG contact 170 voltage is sampled using an A/D converter. The voltage is used to detect the effective PROG contact 170 pull-down resistance 8. This resistance value is used to determine the operational mode of the battery module 1. Modes and PROG contact 170 pull-down resistance 8 values are given in Table 1.

TABLE 1
Operation modes vs. PROG contact pull-down resistance

| | RESISTANCE AT | | VBUS | | | | BATT+ | |
|---|---|---|---|---|---|---|---|---|
| Mode | PROG PIN | | FUNCTION | DIRECTION | VOLTAGE | | OUTPUT | IDEAL DIODE |
| 0 | >1 MΩ (OPEN) | | OFF | OFF | 0 | V | OFF | OFF |
| 1 | 0 | kΩ | CHARGE | INPUT | 3.6 to 26 V | | ON | OFF |
| 2 | 1.0 | kΩ | CHARGE | INPUT | 3.6 to 26 V | | ON | ENABLED |
| 3 | 3.0 | kΩ | MPPT | INPUT | 3.6 to 26 V | | ON | OFF |
| 4 | 4.7 | kΩ | PPS | OUTPUT | 5 | V | ON | OFF |
| 5 | 6.0 | kΩ | PPS | OUTPUT | 9 | V | ON | OFF |
| 6 | 8.2 | kΩ | PPS | OUTPUT | 12 | V | ON | OFF |
| 7 | 10.5 | kΩ | PPS | OUTPUT | 15 | V | ON | OFF |
| 8 | 13.7 | kΩ | PPS | OUTPUT | 20 | V | ON | OFF |

| | | | |
|---|---|---|---|
| 9 | 15 | kΩ | ALL FUNCTIONS CONTROLLED REMOTELY VIA DATA BUS |

Note:
MPPT = Maximum Power Point Tracking algorithm for photovoltaic panel input
PPS = Programmable Power Supply output

The bidirectional DC-DC converter 5 in combination with the control unit 6 controls power flow between the VBUS contact 150 and the battery cells 2 in three modes: charge, MPPT and PPS.

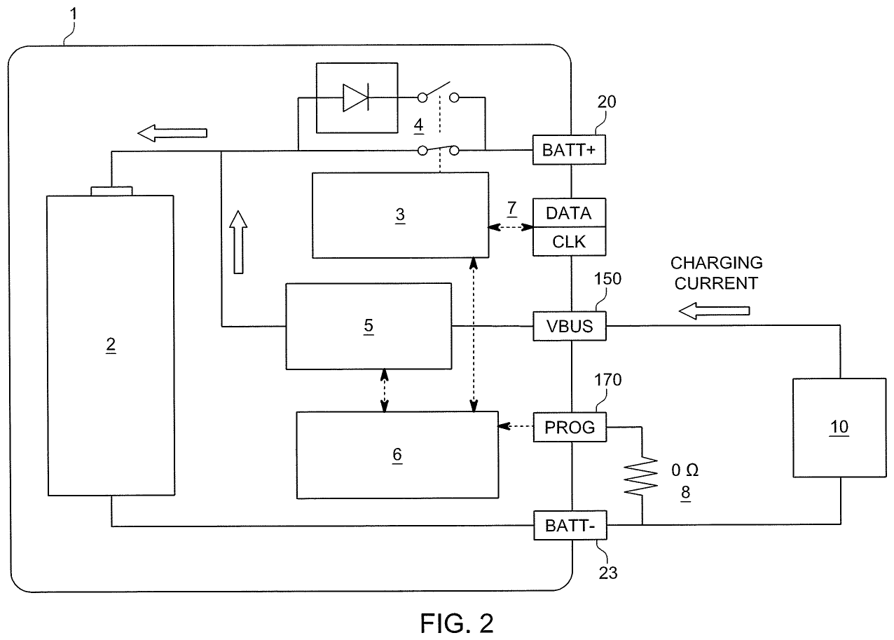

In charge mode, shown in FIG. 2, the VBUS contact 150 is configured as an input and supplies the current to charge the battery cells 2. The voltage supplied to the VBUS can be above or below the voltage of the battery cells 2. Control unit 6 manages the bidirectional DC-DC converter 5 to implement a complete autonomous charging algorithm with no exterior control.

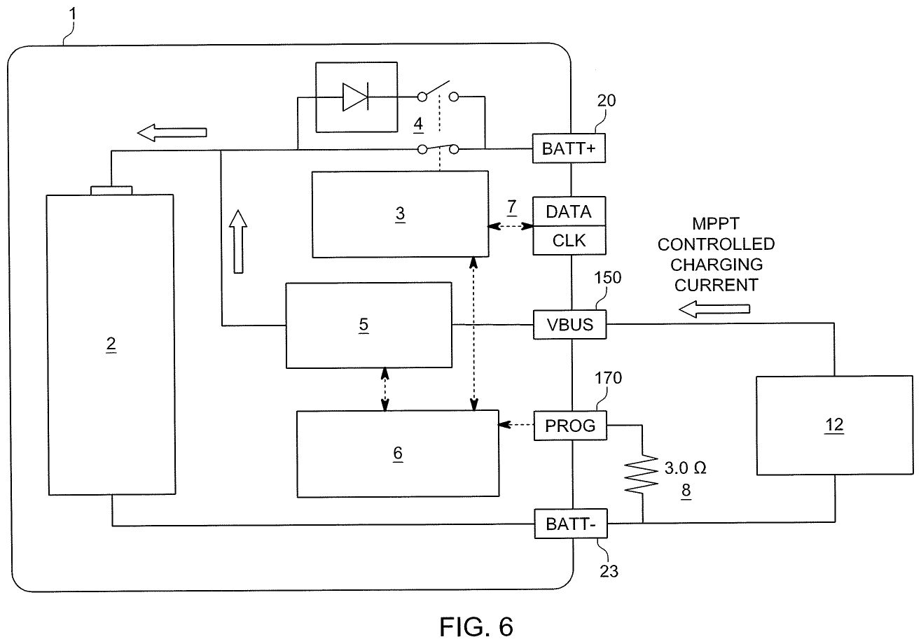

In MPPT (maximum power point tracking) mode, shown in FIG. 6, the VBUS contact 150 is configured as an input that is directly attached to the output of a photovoltaic panel 12. Control unit 6 manages the bidirectional DC-DC converter 5 to implement a complete autonomous MPPT battery charging algorithm with no exterior control.

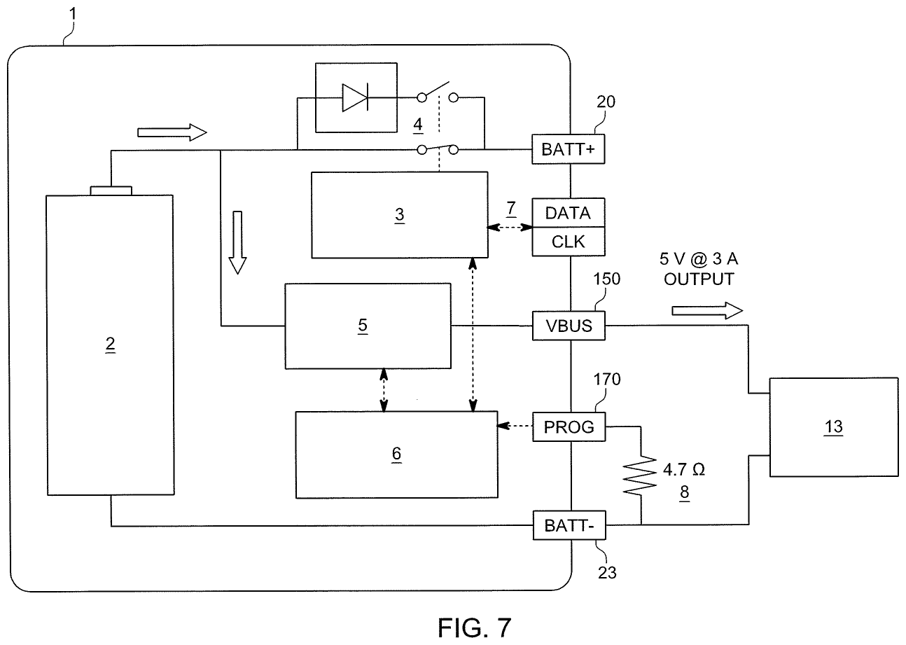

In PPS (programmable power supply) mode, shown in FIG. 7, the VBUS contact 150 is configured as an output. The control unit 6 manages the bidirectional DC-DC converter 5 to convert battery 2 voltage into a fixed output voltage on the VBUS contact 150. One embodiment of this mode is setting the output to 5 V @ 3 A to implement a USB-C power source 13.

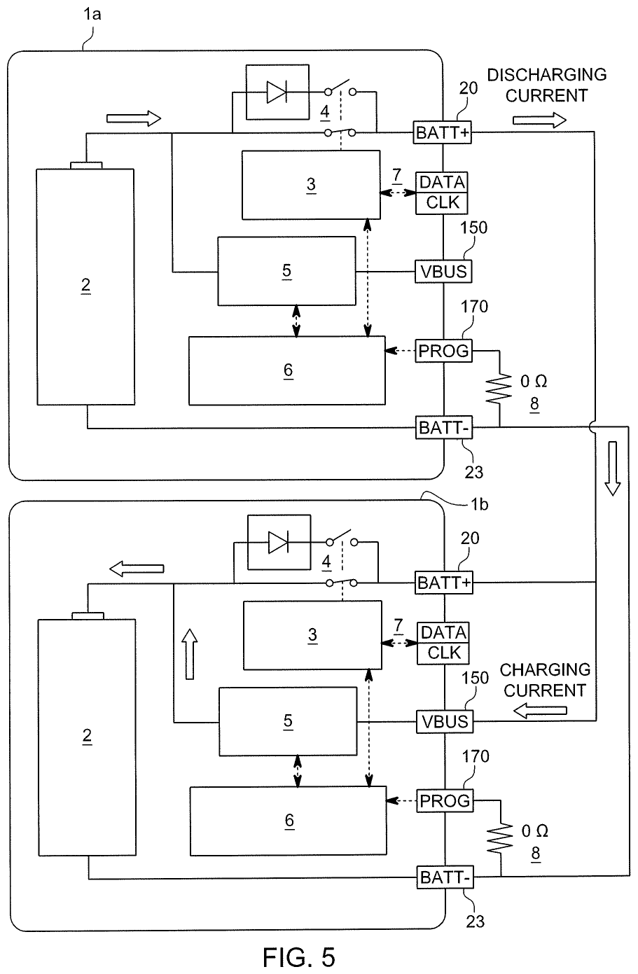

FIG. 5 shows the transfer of power between two battery modules 1A, 1B in Mode 1. The BATT+ output of the source battery module 1A, is connected to the VBUS contact of a second battery module 1B in charge mode.

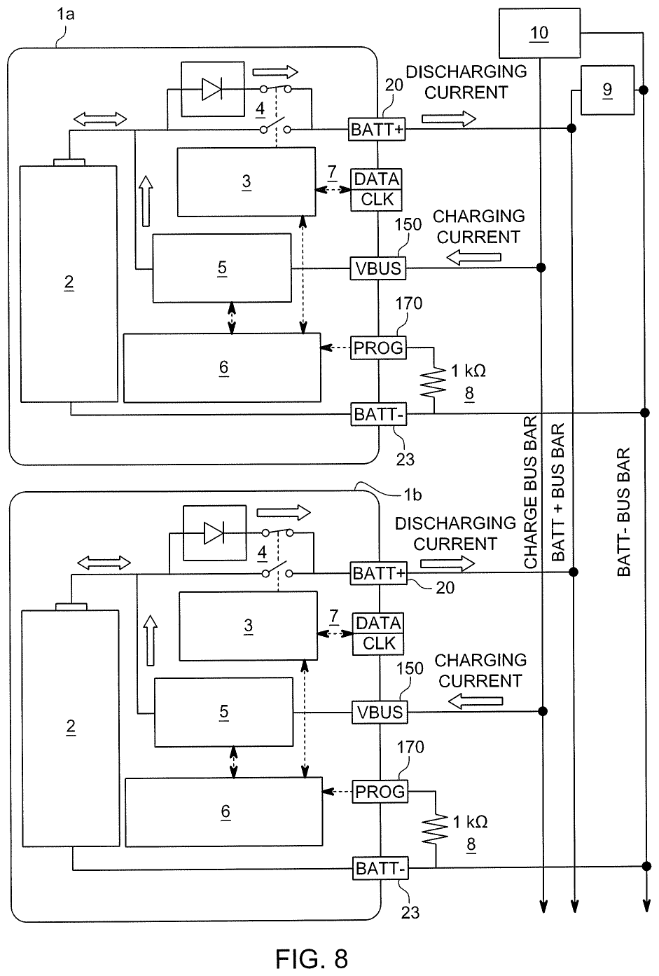

FIG. 8 shows the connection of two battery modules 1A, 1B with the BATT+, BATT− and VBUS contacts connected in parallel to increase the battery output capacity. The ideal diode mode is enabled in the power switch 4 of the battery management system 3 to prevent current from flowing between batteries if they are connected with different states of charge. In this embodiment, a multiple battery bus bar system uses a passive external bus bar connection bus without active balancing i.e. the highest charge battery module will discharge first until its voltage matches the next highest charged battery. In this configuration the battery current will be limited to the maximum limit for one battery, given the worst case scenario of two batteries installed at a greatly different states of charge, but the total capacity will be the combined total charge of the multiple batteries attached to the bus bar.

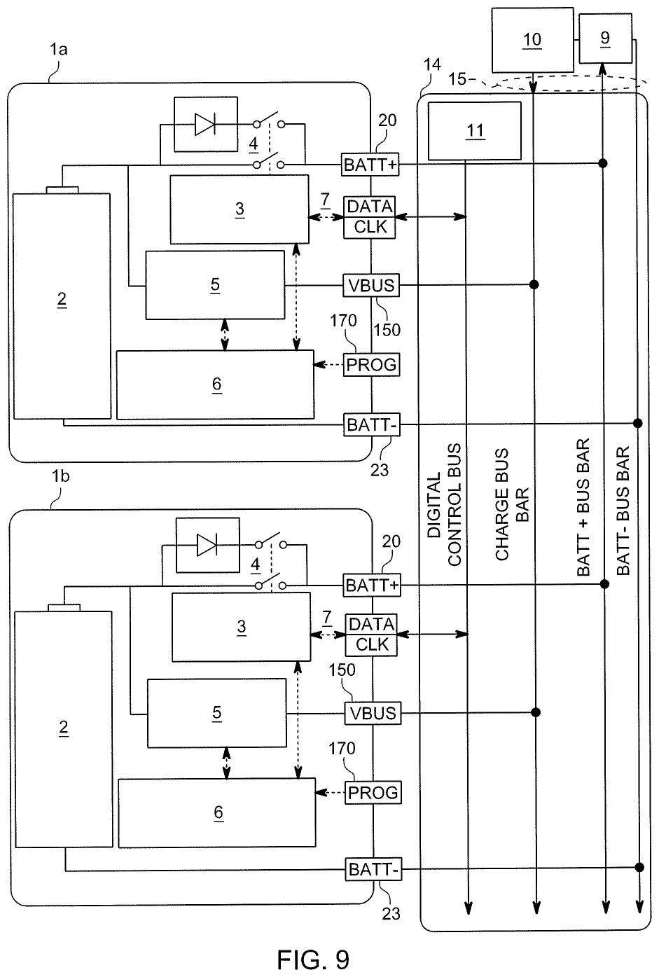

FIG. 9 shows the connection of multiple battery modules 1A, 1B, etc. with a common bus bar for each of the BATT+ 20, BATT− 23 and VBUS contacts 150. The bus bar control unit 14 communicates with the individual data buses 7, control units 6, and battery management systems 3 of each battery using a digital control bus. The output connector 15 connects the bus bars to the load 9 and charging power source 10.

The bus bar control unit 14 can implement balancing of the battery voltages between battery modules 1A, 1B, 1C, ID, etc. by reading the individual battery voltages and selectively transferring charge between batteries using charge bus bar VBUS and control of the individual bidirectional DC-DC converters 5.

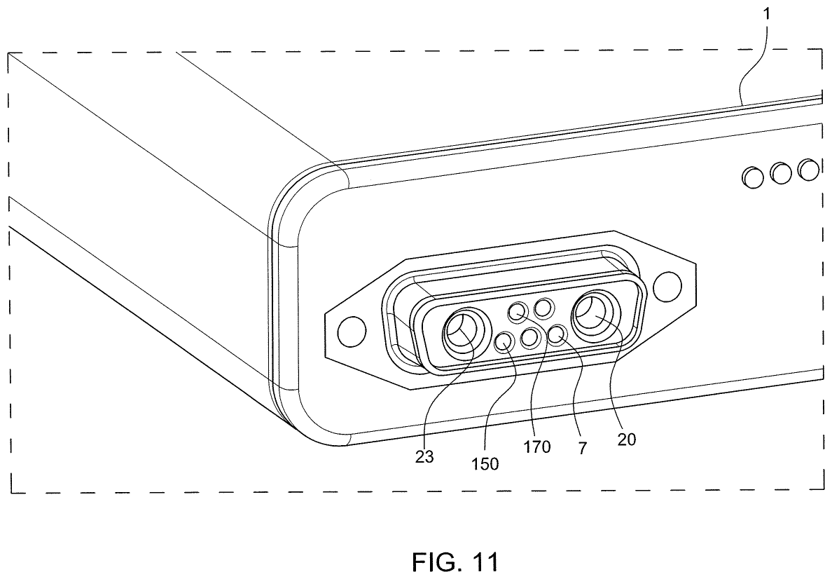

FIG. 11 shows the battery module 1 preferably includes at least 5 contacts: a positive contact BATT+ 20, a negative contact BATT− 23, a clock contact CLK, a data contact DATA, and a program contact PROG 170. The clock and data contacts 7 (CLK, DATA) transfer information between the battery control unit 6 and a host device. The host device can read information from battery management system 3, such as % remaining capacity, voltage temperature, current, etc., as well as control the operation of the bidirectional DC-DC converter 5 and load switch 4 for ideal diode mode.

The present invention contemplates that many changes and modifications may be made. Therefore, while the presently-preferred form of the interoperable micropower system has been shown and described, and several modifications and alternatives discussed, persons skilled in this art will readily appreciate that various additional changes and modifications may be made without departing from the spirit of the invention, as defined and differentiated by the following claims.

1. A battery module comprising:
a plurality of battery cells configured to store electrical energy;
a battery management system (BMS) coupled to the plurality of battery cells, wherein the BMS is configured to monitor and manage the performance and safety of the of the battery cells;
a battery load switch operatively connected between the plurality of battery cells and an external load, wherein the battery load switch is configured to selectively connect and disconnect the battery cells from the load;
a bidirectional voltage converter circuit connected to the plurality of battery cells and the battery load switch, wherein the bidirectional converter circuit is configured to convert voltage levels during charging and discharging of the battery cells; and,
a control unit in communication with the battery management system, the battery load switch, and the bidirectional voltage circuit wherein the control unit is configured to: receive operational data from the battery management system, control the operation of the battery load switch based on the received operational data, and regulate the bidirectional voltage converter circuit to manage the flow of energy between the battery cells and the external load.

2. The battery module of claim 1, wherein the control unit configures the operation of the bidirectional voltage converter and battery load switch based on the pull-down resistance value presented to a contact on the battery module.

3. The battery module of claim 1, wherein the battery load switch is configured to operate as an ideal diode.

4. The battery module of claim 1, wherein the battery load switch is controlled by the battery management system in series with the battery control unit.

5. The battery module of claim 1, wherein the bidirectional voltage converter is configured to implement charging of the battery from a VBUS contact.

6. The battery module of claim 1, wherein the bidirectional voltage converter is configured to implement an MPPT charging algorithm of the battery from a VBUS contact.

7. The battery module of claim 1, wherein the bidirectional voltage converter is configured as a programmable power source to draw power from the battery cells to output a voltage on a VBUS contact.

8. The battery module of claim 2, wherein the control unit is configured to enable and disable the battery load switch and ideal diode mode.

9. The battery module of claim 2, wherein the control unit is further controlled by an external data bus.

10. A battery bus bar comprising:
a plurality of removable battery modules according to claim 1;
a control unit configured to monitor and manage the operation of the removable battery modules;
a battery power bus bar connected to electrical terminals of the plurality of removable battery modules, wherein the battery power bus bar is configured to facilitate the transfer of electrical power between the removable battery modules and an external load;
a battery charge bus bar connected to the electrical terminals of the plurality of removable battery modules, wherein the battery charge bus bar is configured to facilitate the charging of the removable battery modules from an external power source; and,
a battery data bus configured to provide communication between the removable battery modules and the control unit, wherein the battery data bus enables the control unit to monitor the status and performance of each removable battery module.

11. The battery bus bar of claim 10, wherein the control unit connects to the battery data bus of each removable battery module.

12. The battery bus bar of claim 10, wherein battery power contacts of the removable battery modules connect in parallel.

13. The battery bus bar of claim 10, wherein battery charge contacts of the removable battery modules connect in parallel.

14. The battery bus bar of claim 10, where the control unit implements a battery balancing algorithm.

15. The battery bus bar of claim 10, where the control unit transfers charge between individual battery modules through the charge bus bar and control of the individual bidirectional voltage converters.

16. The battery bus bar of claim 10, wherein a MPPT charging algorithm is implemented using control over the bidirectional voltage converters to regulate the charging to the individual battery modules from a photovoltaic panel attached to the battery charge bus bar.
